(19) United States
(12) Patent Application Publication
(10) Pub. No.: US 2015/0059494 A1
(43) Pub. Date: Mar. 5, 2015

(54) METHODS, SYSTEMS AND DEVICES FOR MEASURING AND MONITORING IMPACT FORCES IMPARTED TO INDIVIDUALS, AND PROTECTING INDIVIDUALS FROM IMPACT FORCES

(71) Applicant: Kaydon A. Stanzione, Sewell, NJ (US)

(72) Inventor: Kaydon A. Stanzione, Sewell, NJ (US)

(21) Appl. No.: 14/475,978

(22) Filed: Sep. 3, 2014

Related U.S. Application Data
(60) Provisional application No. 61/873,015, filed on Sep. 3, 2013.

(51) Int. Cl. G01L 1/00; A63B 71/08

(52) U.S. Cl. CPC G01L 1/00; A63B 71/08
USPC 73/862.381

(57) ABSTRACT

A system for monitoring and measuring impact forces imparted to an individual using force sensors, electronics for real-time transmission of sensed data to a remote server, software algorithms to calculate effects of the sensed forces and to determine whether to send an alert notification to at least one remote recipient. Embodiments further include individual body protection devices using multi-layer composite materials that are sized and shaped to an individual, and incorporating at least one force sensor, and electronics for real-time transmission of sensed data to a remote server having software algorithms to calculate effects of sensed forces and to determine whether to send an alert notification to at least one remote recipient, as disclosed in the specification of this application.

### CROSS REFERENCE TO RELATED APPLICATIONS

This application claims priority to U.S. patent application Ser. No. 61/873,015, filed Sep. 3, 2013, the contents of which are incorporated by reference in this document, in their entirety and for all purposes.

### TECHNICAL FIELD

The present invention relates generally to protective equipment, and particularly to protective equipment with force sensing and measuring capabilities.

### BACKGROUND OF THE INVENTION

Impact forces may be imparted to people or animals in a variety of environments or circumstances. For example, in sports activities. or in military operations. or law enforcement duties, and even with patients before, during, or after medical procedures, impact forces may be imparted to an individual. Such forces if large or severe enough could result in injury or trauma to the individual. Often times, the effect of an impact force on an individual is not fully recognized or known because of the event in which the force is imparted, or simply because the injury or trauma does not immediately manifest into an observable effect.

While there has been a known need to minimize force impacts that may be transmitted to or imparted to an individual's body, including to an individual's head area. and thereby reduce, for example brain trauma. the current technology does not appear to provide an effective means for monitoring, measuring or protecting an individual with severely restricting motion or comfort. Moreover, the current devices and systems do not appear to provide for an ability to measure or monitor impact forces, and in real-time analyze such data and provide an alert to a remote device should the analyzed data show that an alert condition has occurred.

Accordingly, what is still needed, are methods, systems and devices that measure and monitor impact forces imparted to individuals, and for protecting individuals from impact forces. Such methods, systems and devices are disclosed and described below and in the attached documents. Such methods, systems, and devices, as described herein have not previously existed.

### SUMMARY OF THE INVENTION

Embodiments of the present invention include systems for monitoring and measuring impact forces imparted to an individual including force sensors electronics for real-time transmission of data from the force sensors to a remote server; and software algorithms stored on the remote server to calculate effects of the sensed forces and to determine whether to send an alert notification to at least one remote recipient.

Embodiments further include individual body protection devices including a multi-layer composite material that is sized and shaped to an individual; at least one force sensor; and electronics for real-time transmission of sensed data from the at least one force sensor to a remote server having software algorithms to calculate effects of sensed forces and to determine whether to send an alert notification to at least one remote recipient.

### BRIEF DESCRIPTION OF THE DRAWING

The invention is best understood from the following detailed description when read in connection with the accompanying drawing. It is emphasized that, according to common practice, the various features of the drawing are not to scale. On the contrary, the dimensions of the various features are arbitrarily expanded or reduced for clarity. Included in the drawing are the following figures:

FIG. 1 is a photograph of a self-contained wireless sensor, according an embodiment of the present invention;

FIG. 2 is a photograph of the wireless sensor of FIG. 1 being installed into shoulder pads, according an embodiment of the present invention;

FIG. 3 is a photograph of the wireless sensor of FIG. 1 being installed into a helmet, according an embodiment of the present invention;

FIG. 4 is a photograph of the wireless sensor of FIG. 1 installed into the helmet of FIG. 3, according an embodiment of the present invention;

FIG. 5 is a photograph of wireless controller, according an embodiment of the present invention;

FIG. 6 is a photograph of wireless controller, according an embodiment of the present invention;

FIG. 7 is a screenshot of a cloud-based software for monitoring sensor data, according an embodiment of the present invention;

FIG. 8 is a template for a dual-use protective plate, according an embodiment of the present invention;

FIG. 9 is a photograph of a front view of protective plate made from the template of FIG. 8, according an embodiment of the present invention;

FIG. 10 is a photograph of fitting an embodiment of the present invention to preexisting football equipment;

FIG. 11 is a photograph of a side view of protective plate, according an embodiment of the present invention;

FIG. 12 is a photograph of a view of protective plate, according an embodiment of the present invention;

FIG. 13 is a photograph of a view of protective plate, according an embodiment of the present invention;

FIG. 14 is a photograph of a protective abdominal body wrap, according an embodiment of the present invention;

FIG. 15 is a chart of various layers that comprise a protective layer, according an embodiment of the present invention;

FIG. 16 is a photograph of template for a protection plate, according an embodiment of the present invention;

FIG. 17 is a photograph of a top view of a protection plate with attached sensor housing, according an embodiment of the present invention;

FIG. 18 is a photograph of a protective body wrap with sensors, according an embodiment of the present invention;

FIG. 19 is a photograph of a protective body wrap with sensors, according an embodiment of the present invention;

FIG. 20 is a photograph of a protective body wrap with sensors in a wrapped position, according an embodiment of the present invention;

FIG. 21 is a photograph of a protective body wrap with sensors in an open position, according an embodiment of the present invention;

FIG. 22 is a photograph of protective rigid plate, according an embodiment of the present invention; and

FIG. 23 is a photograph of a person wearing a protective shoulder pad, and protective body wrap, according an embodiment of the present invention.

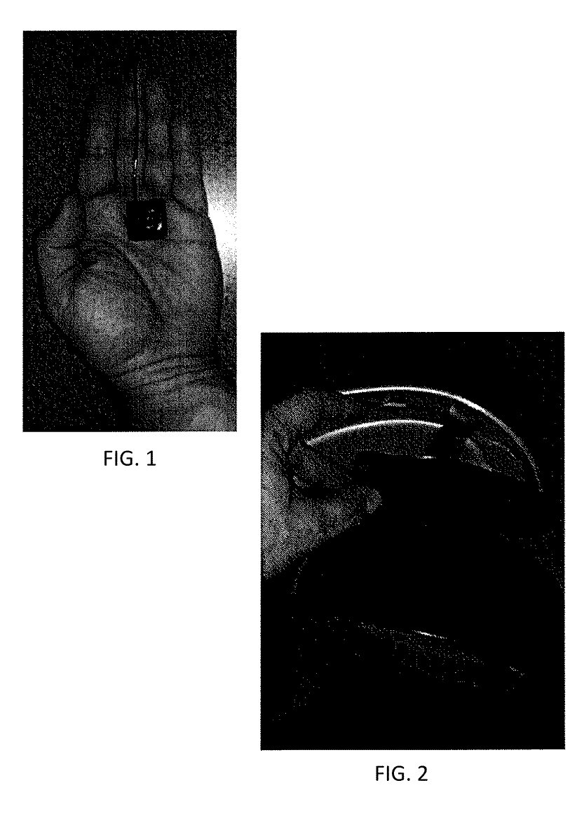

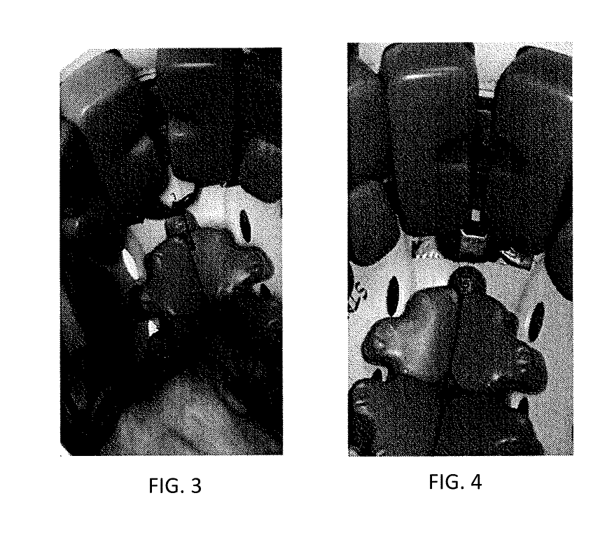

### DETAILED DESCRIPTION

Referring now to the drawing, in which like reference numbers refer to like elements throughout the various figures that comprise the drawing, embodiments of the present invention include methods, systems and devices for measuring and monitoring impact forces that may be imparted to individuals, and for protecting individuals from impact forces are disclosed and described.

Embodiments include systems having force and accelerometer sensors placed on or within equipment or apparel worn by the individual, along with electronics that permit the real-time transmission of some or all measured and monitored signals to a remote server for analysis using appropriate algorithms to determine, among other calculations, the level of force imparted. The systems then are capable of providing an alert notification to one or more remote recipients who are communicatively connected to the remote server and have requested real-time alert notification information about the individuals wearing the monitoring equipment.

Embodiments also include algorithms using the sensed impact force data to calculate effects of such forces on the individual or body parts of the individual, and to compare such forces to a stored database of similar forces to determine whether an alert notification should be provided as a result of the impact forces imparted and sensed.

Embodiments also include devices made of multi-layered composite materials that are sized and shaped to an individual in a customized fashion and may incorporate one or more of the force and accelerometer sensors and associated electronics.

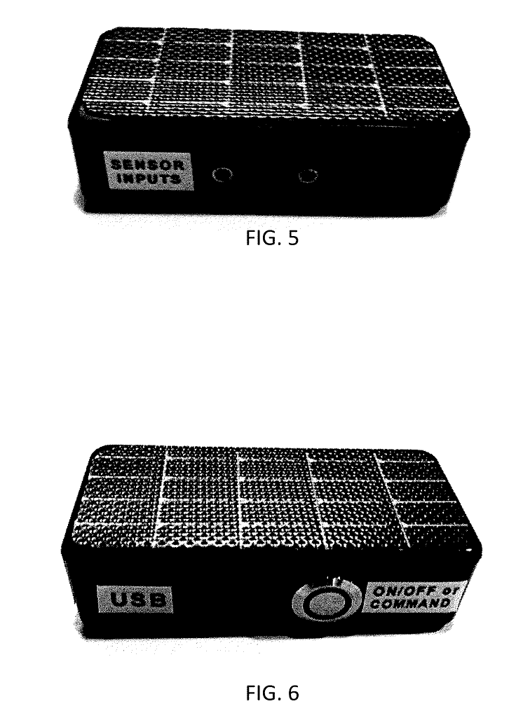

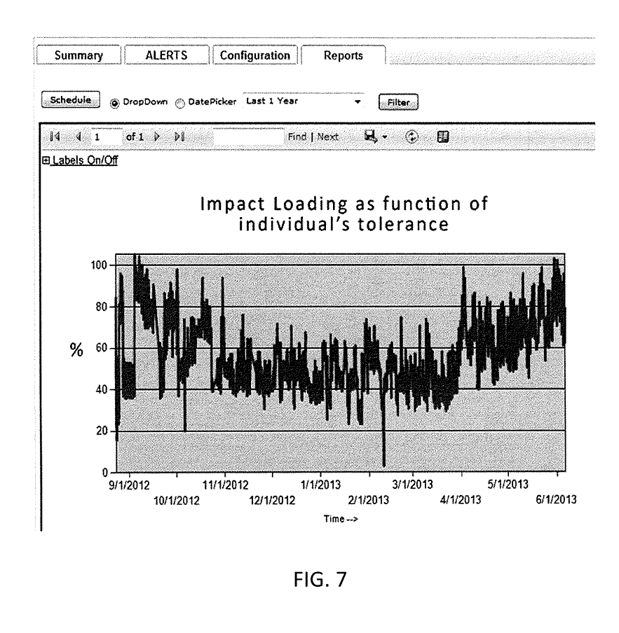

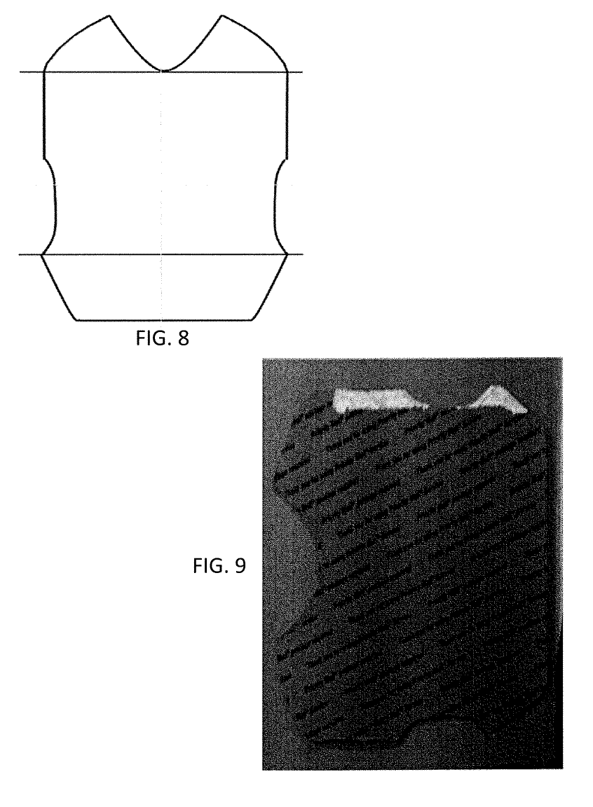

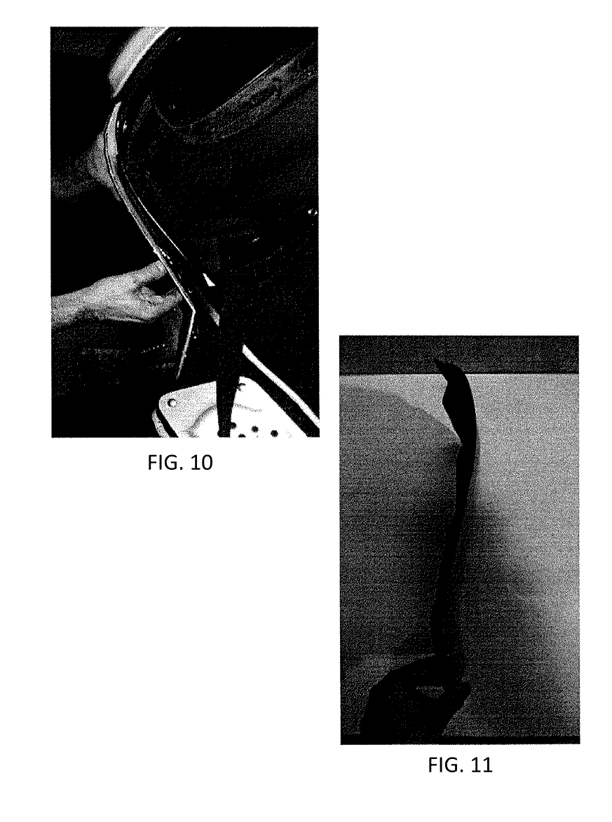

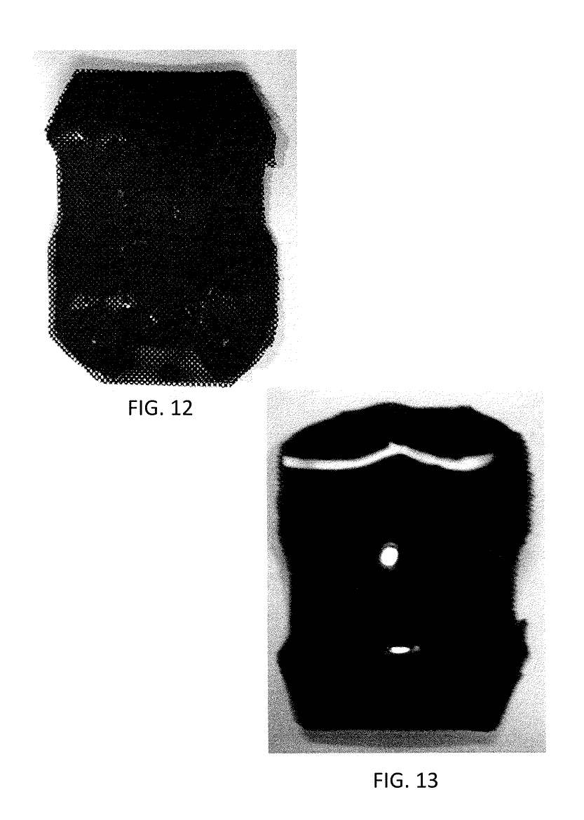

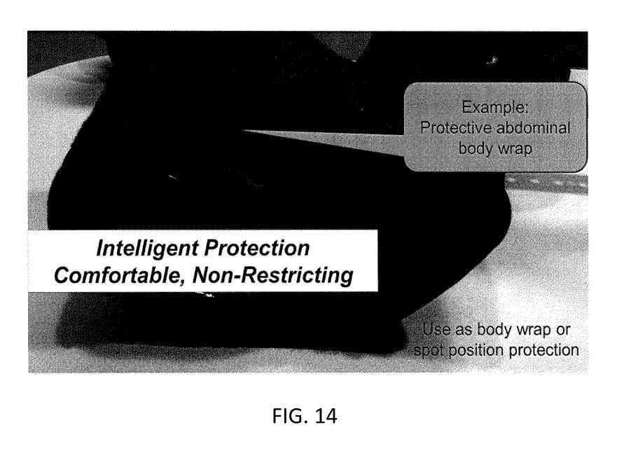

By way of example only, in a preferred embodiment of the inventive methods and systems, the following components are used: a plurality of electronic sensors, which may be in the form of printed circuit boards, are modified to be included on or within apparel or equipment to be worn by the individual; a wireless controller in communicative connection with the electronic sensors, where the wireless controller includes a radio that receives signals from the electronic sensors and then transmits the signals to a remote server, preferably using the cloud, and software operated by the remote server, also preferably using the cloud, where the software processes the received signals to determine different output aspects of the imparted forces and then retransmits the output calculations to at least one remote wireless device, possibly in the form of an alert notification relating to the imparted force and output calculations. In an embodiment, the wireless controller may further include a solar skin to provide power to the controller and wire inputs for non-wireless sensors (FIG. 5). The controller may further include an on/off button capable of also sending an emergency alert (FIG. 6). The controller may further include an input/output port such as a USB connection for communication with remote devices not in wireless communication with the controller.

An example of the operation of the inventive system and methods is protective equipment for use in a football game. In a football player embodiment, the electronic sensors may be placed in a player's helmet, shoulder pads, chest or torso protector, or spine, hip or thigh pads. When an impact occurs, which could be normal hit or tackle, the sensors measure the impact force and register the location of the initial impact, along with the resulting forces transmitted through the individual's body. This sensed information is recorded and compared to a stored database of other impact forces. Where the senses force exceeds set tolerances based upon the comparisons, then algorithm are generated or calculated to determine whether the impact may have an adverse effect. The algorithms calculated can be used to identify traumatic brain impact (e.g., a concussion), or a deep force impact injury. The results of the algorithm calculations can further be transmitted to any remote user device, including a caregiver.

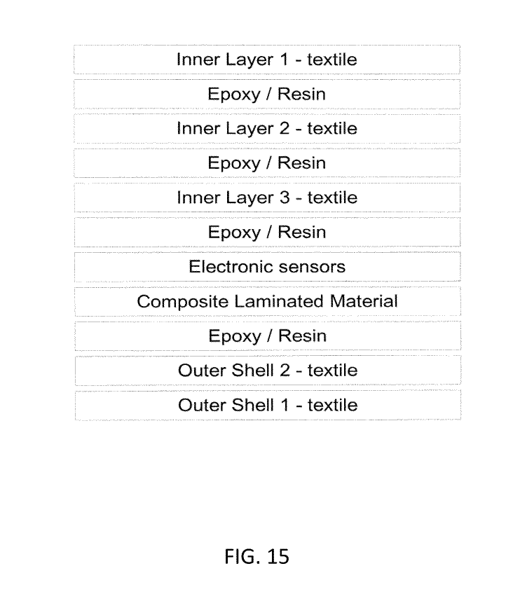

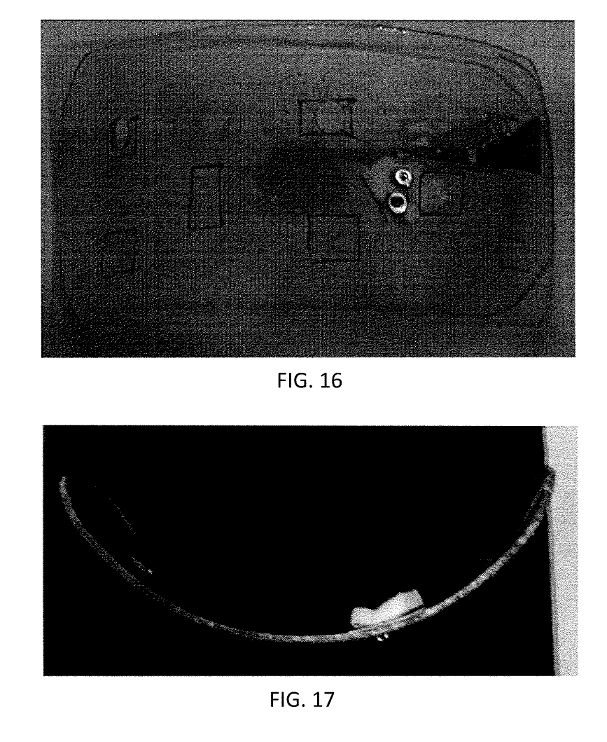

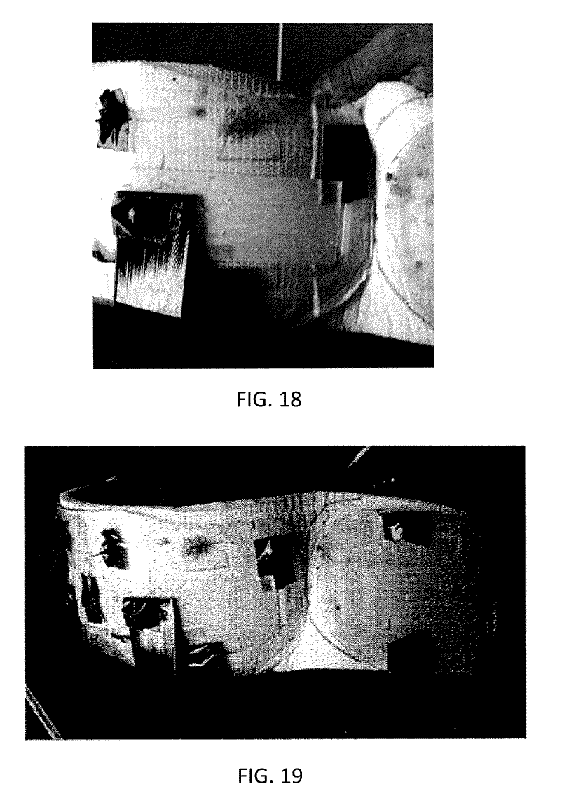

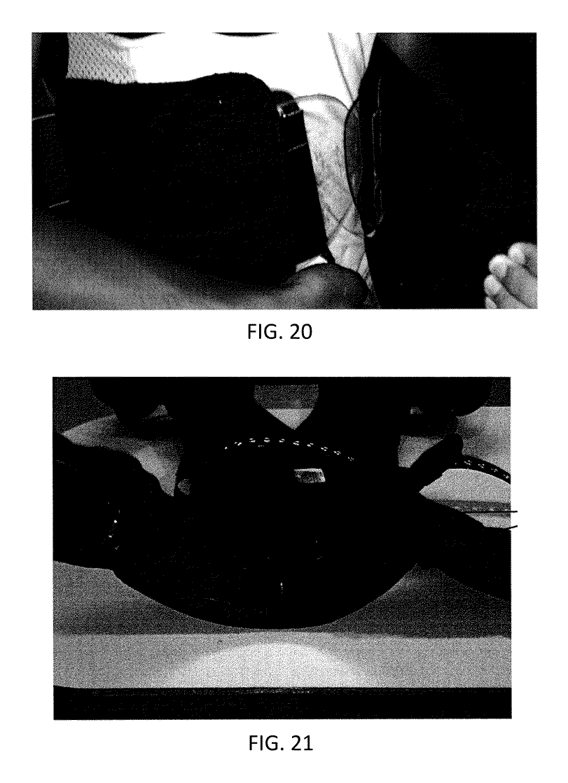

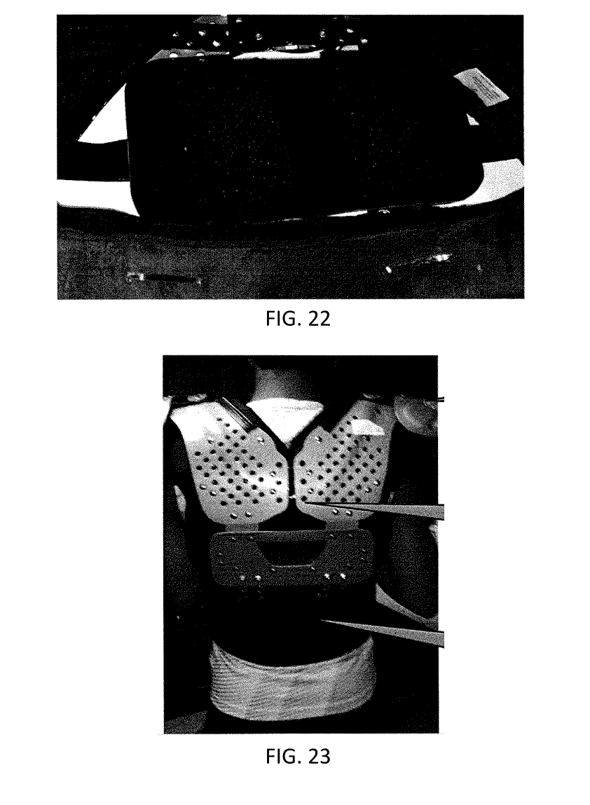

In a further preferred embodiment of the inventive devices for protecting individuals from force impacts, a laminated torso (for chest or back protection) plate is custom fit for the specific individual to be protected. The plate is customized to include the number of layers needed for the activity to be experiences, and/or the forces to be protected against. By way of one example, as described in FIG. 15, the plate may include three layers of textiles with epoxy I resin binding agents, along with the electronic sensors, and multiple layers of outer textile shells. The devices can be custom fit for various football player applications, and can be custom fit for chest, back, torso mid-section. or arm or leg uses.

Certain preferred embodiments and examples of the inventive methods, systems and devices for measuring and monitoring impact forces that imparted to individuals, and for protecting individuals from impact forces have been described herein. It is to be understood that various modifications may be made to these described embodiments without departing from the spirit and scope of the invention. All such modifications and other embodiments are intended to be within the scope of the above description and in the following claims.

More particularly while certain exemplary embodiments of the inventive systems, methods and devices have been disclosed and described, there may be other system architectures, and method steps that may provide for alternative methods, systems or devices that may provide a means for measuring and monitoring impact forces, using for example different materials or algorithms for monitoring such forces. Such alternative methods, systems and devices are equally possible and are expected to use similar method steps, system elements, and device elements and materials as disclosed herein. Such equivalent configurations are deemed fully within the scope of the claimed inventive methods, systems and devices for measuring and monitoring impact forces that imparted to individuals, and for protecting individuals from impact forces. Those having ordinary skill in the art and access to the teachings provided herein will recognize additional modifications, applications, embodiments and substitution of equivalents all of which are within the scope of the invention. Accordingly, the invention is not to be considered as limited by the specific foregoing description.

1. A system for monitoring and measuring impact forces imparted to an individual, the system comprising:
force sensors,
electronics for real-time transmission of data from the force sensors to a remote server; and
software algorithms stored on the remote server to calculate effects of the sensed forces and to determine whether to send an alert notification to at least one remote recipient.

2. Individual body protection devices comprising:
a multi-layer composite material that is sized and shaped to an individual;
at least one force sensor; and
electronics for real-time transmission of sensed data from the at least one force sensor to a remote server having software algorithms to calculate effects of sensed forces and to determine whether to send an alert notification to at least one remote recipient.
